(19) United States
(12) Patent Application Publication
(10) Pub. No.: US 2018/0106076 A1
(43) Pub. Date: Apr. 19, 2018

(54) NEW PET CAGE DOOR

(71) Applicant: Hongkun LIANG, Zhong shan City (CN)

(72) Inventor: Hongkun LIANG, Zhong shan City (CN)

(21) Appl. No.: 15/562,668

(22) PCT Filed: Mar. 8, 2016
(86) PCT No.: PCT/CN2016/075825

§ 371 Date: Sep. 28, 2017

(30) Foreign Application Priority Data
Nov. 11, 2015 (CN) 201520899654.2

(51) Int. Cl. E05B 63/14; A01K 1/02; A01K 1/03

(52) U.S. Cl. CPC E05B 63/14; A01K 1/03; A01K 1/0245

(57) ABSTRACT

A pet cage door including a door frame and a door capable of opening and closing relative to the door frame. A locking device is disposed between the door and the door frame and includes a housing disposed on the door. A horizontal locking tongue which is horizontally movable to insert into a horizontal socket in the door frame is disposed in the housing, and a vertical locking bar which is vertically movable to insert into a vertical socket in the door frame is also disposed in the housing. The housing is also provided with a drive mechanism which is matched with the horizontal locking tongue and drives the vertical locking bar to unlock while driving the horizontal locking tongue to unlock.

### TECHNICAL FIELD

The present utility model relates to a new pet cage door.

### RELATED ART

As many people will keep small animals as pets in today's social life, pet cage is necessary naturally. In particular, many users will take their pets with pet cages for long flight. However, a traditional pet cage door has the following disadvantages: only one inserted bar which moves up and down is disposed between a door and a door frame to lock, and there is no locking tongue in the horizontal direction, that is, only a vertical locking point is disposed between the door and the door frame. When a pet cage is relatively large, a pet therein can push the door from the side, the upper edge or the lower edge of the door frame to form a relatively narrow exit, and then the pet will run out through the exit. Every time this happens, the user not only has to bear the loss of money, but also to bear the psychological pain due to loss of their dear partners.

Therefore, the present utility model is generated based on the foregoing disadvantages.

### SUMMARY

An objective of the present utility model is to overcome disadvantages in the prior art to provide a new pet cage door which is simple in structure and convenient to operate and is capable of locking a door and a door frame firmly so as to prevent a pet from running out.

The present utility model is implemented by means of the following technical solutions:

A new pet cage door comprises a door frame 1 and a door 2 capable of opening and closing relative to the door frame 1, a locking device 3 is disposed between the door 2 and the door frame 1, wherein the locking device 3 comprises a housing 31 disposed on the door 2, a horizontal locking tongue 32 which is horizontally movable to insert into a horizontal socket in the door frame 1 is disposed in the housing 31, a vertical locking bar 33 which is vertically movable to insert into a vertical socket in the door frame 1 is disposed in the housing 31, the housing 31 is also provided with a drive mechanism 34 which is matched with the horizontal locking tongue 32 and drives the vertical locking bar 33 to unlock while driving the horizontal locking tongue 32 to unlock.

According to the new pet cage door as stated above, the drive mechanism 34 comprises an annular groove 341 disposed in the horizontal locking tongue 32, a plurality of convex first teeth 342 are disposed on at least one straight side wall of the annular groove 341, a drive gear 343 matched with the first teeth 342 to drive the horizontal locking tongue 32 to move horizontally is disposed in the annular groove 341, a vertically-arranged vertical sliding block 344 is disposed in the housing 31, a plurality of second teeth 345 capable of being matched with the drive gear 343 to drive the vertical sliding block 344 to move vertically are disposed on the vertical sliding block 344, and the vertical locking bar 33 is connected onto the vertical sliding block 344.

According to the new pet cage door as stated above, a first reset spring 346 used for moving the vertical sliding block 344 to reset is disposed in the housing 31.

According to the new pet cage door as stated above, the drive mechanism 34 comprises a rotating bar 34a capable of rotating in the housing 31, a horizontal hinge part 34b and a vertical hinge part 34c are disposed on the rotating bar 34a, a first interlocking plate 34d hinged with the horizontal hinge part 34b and the horizontal locking tongue 32 is disposed therebetween, the housing 31 is internally provided with a vertical sliding base 34e capable of sliding up and down therein, a second interlocking plate 34f hinged with the vertical hinge part 34c and the vertical sliding base 34e is disposed therebetween, and the vertical sliding base 34e is connected with the vertical locking bar 33.

According to the new pet cage door as stated above, a second reset spring 34g used for moving the vertical sliding base 34e to reset is disposed in the housing 31.

According to the new pet cage door as stated above, two vertical sliding blocks 344 are arranged, and are disposed on the upper and lower sides of the horizontal locking tongue 32, the second teeth 345 on the two vertical sliding blocks 344 are respectively matched with the drive gear 343 so that the two vertical sliding blocks 344 may vertically move towards each other in opposite directions or move backwards when the drive gear 343 rotates, two vertical locking bars 33 are arranged, and are connected with the vertical sliding blocks 344, and the two bars are matched with an upper frame and a lower frame of the door frame 1 respectively.

According to the new pet cage door as stated above, two vertical sliding bases 34e are arranged, and are disposed on the upper and lower sides of the horizontal locking tongue 32 respectively, the number of the vertical hinge parts 34c on the rotating bar 34a is two and the two parts are disposed on the upper and lower sides of the horizontal hinge part 34b respectively, and the number of the second interlocking plates 34f is two and the two plates are disposed on the upper and lower sides of the horizontal locking tongue 32 respectively to connect the corresponding vertical sliding base 34e and vertical hinge part 34c.

According to the new pet cage door as stated above, the housing 31 comprises an upper housing 311 and a lower housing 312, the lower housing 312 is internally provided with a horizontal bar 313, and the first reset spring 346 is disposed between the vertical sliding block 344 and the horizontal bar 313.

According to the new pet cage door as stated above, the housing 31 comprises an upper housing 311 and a lower housing 312, the lower housing 312 is internally provided with a horizontal plate 314, and the second reset spring 31 is disposed between the vertical sliding base 34e and the horizontal plate 314.

According to the new pet cage door as stated above, a rotating handle 347 exposed out of the housing 31 is connected onto the drive gear 343.

As compared with the prior art, the present utility model has the following advantages:

1. A horizontal locking tongue which is horizontally movable to insert into a horizontal socket in a door frame is disposed in a housing of the present utility model, a vertical locking bar which is vertically movable to insert into a vertical socket in the door frame is disposed in the housing, and the housing is also provided with a drive mechanism which is matched with the horizontal locking tongue and drives the vertical locking bar to unlock while driving the horizontal locking tongue to unlock. The door is locked with the door frame by the horizontal locking tongue and the vertical locking bar so that the number of locking points between the door and the door frame is at least two, which enhances the locking firmness of the door and avoids a pet from running out. In addition, the drive mechanism can drive the vertical locking bar to move while driving the horizontal locking tongue to move so that the horizontal locking tongue is consistent with the vertical locking bar in terms of action, thereby the operation is more convenient and faster.

2. The drive mechanism of the present utility model comprises an annular groove disposed in the horizontal locking tongue, a plurality of convex first teeth are disposed on at least one straight side wall of the annular groove, a drive gear matched with the first teeth to drive the horizontal locking tongue to move horizontally is disposed in the annular groove, a vertically-arranged vertical sliding block is disposed in the housing, a plurality of second teeth capable of being matched with the drive gear to drive the vertical sliding block to move vertically are disposed on the vertical sliding block, and the vertical locking bar is connected onto the vertical sliding block. A first reset spring used for moving the vertical sliding block to reset is disposed in the housing. When the door needs to be opened, the drive gear is rotated and the drive gear is matched with the first teeth on the horizontal locking tongue to drive the horizontal locking tongue to quit from the horizontal socket of the door frame. While the drive gear is matched with the horizontal locking tongue, the drive gear is matched with the second teeth on the vertical sliding block, which in turn drives the vertical sliding block to move vertically, thereby driving the vertical locking bar on the vertical sliding block to quit from the vertical socket in the door frame, thus finishing the unlocking between the door and the door frame. The present utility model has a simple structure, and is easy and quick for a user to operate.

3. The drive mechanism of the present utility model may be of another structure which comprises a rotating bar capable of rotating in the housing, a horizontal hinge part and a vertical hinge part are disposed on the rotating bar, a first interlocking plate hinged with the horizontal hinge part and the horizontal locking tongue is disposed therebetween, the housing is internally provided with a vertical sliding base capable of sliding up and down therein, a second interlocking plate hinged with the vertical hinge part and the vertical sliding base is disposed therebetween, and the vertical sliding base is connected with the vertical locking bar. When the door needs to be opened, the rotating bar is rotated. Since the first interlocking plate between the horizontal hinge part on the rotating bar and the horizontal locking tongue is hinged therewith, the first interlocking plate is capable of pulling the horizontal locking tongue to move horizontally when the rotating bar is rotated. Since the second interlocking plate between the vertical hinge part on the rotating bar and the vertical sliding base is hinged therewith, the second interlocking plate is capable of pulling the vertical sliding base to move vertically when the rotating bar is rotated, the horizontal locking tongue and the vertical sliding base thus move horizontally and vertically respectively when the rotating rod is rotated, thus unlocking the horizontal locking tongue and the vertical locking bar from the door frame. The present utility model has a simple structure, and is easy and quick for a user to operate.

4. The present utility model is simple in structure, convenient to operate, low in cost, easy to manufacture and suitable for popularization.

### BRIEF DESCRIPTION OF THE DRAWINGS

FIG. 1 is a three-dimensional diagram of Embodiment 1 of the present utility model;

FIG. 2 is an enlarged view of a position A in FIG. 1;

FIG. 3 is a three-dimensional diagram 1 of a part in Embodiment 1 of the present utility model;

FIG. 4 is an enlarged view of a position B in FIG. 3;

FIG. 5 is a three-dimensional diagram 2 of a part in Embodiment 1 of the present utility model;

FIG. 6 is an exploded view of a part in Embodiment 1 of the present utility model;

FIG. 7 is a three-dimensional diagram 1 of a part in Embodiment 2 of the present utility model;

FIG. 8 is an enlarged view of a position C in FIG. 7;

FIG. 9 is a three-dimensional diagram 2 of a part in Embodiment 2 of the present utility model; and

FIG. 10 is an exploded view of a part in Embodiment 2 of the present utility model.

### DETAILED DESCRIPTION

The present utility model is further described below with reference to the accompanying drawings.

### Embodiment 1

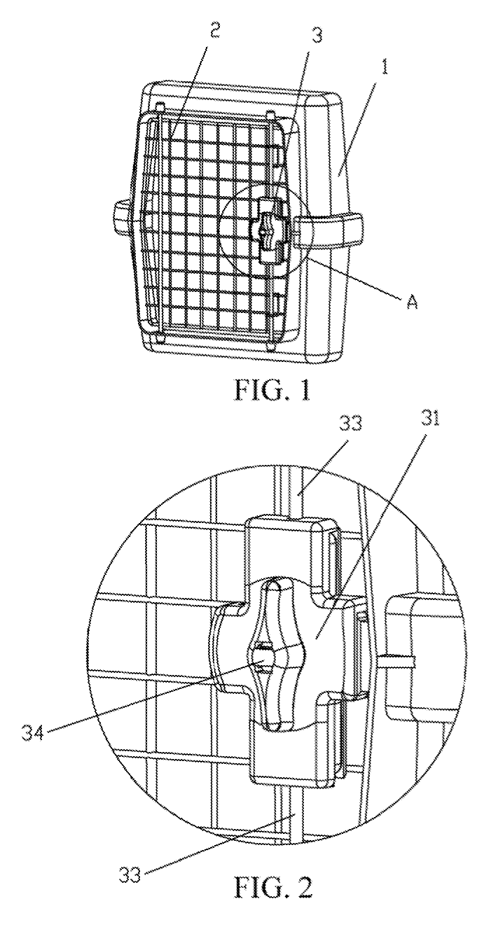

As shown in FIG. 1 and FIG. 2, a new pet cage door comprises a door frame 1 and a door 2 capable of opening and closing relative to the door frame 1, and a locking device 3 is disposed between the door 2 and the door frame 1. The locking device 3 comprises a housing 31 disposed on the door 2, a horizontal locking tongue 32 which is horizontally movable to insert into a horizontal socket (not shown in the figures) in the door frame 1 is disposed in the housing 31, a vertical locking bar 33 which is vertically movable to insert into a vertical socket (not shown in the figures) in the door frame 1 is disposed in the housing 31, and the housing 31 is also provided with a drive mechanism 34 which is matched with the horizontal locking tongue 32 and drives the vertical locking bar 33 to unlock while driving the horizontal locking tongue 32 to unlock. The door 2 is locked with the door frame 1 by the horizontal locking tongue 32 and the vertical locking bar 33 so that the number of locking points between the door 2 and the door frame 1 is at least two, which enhances the locking firmness of the door 2 and avoids a pet from running out. In addition, the drive mechanism 34 can drive the vertical locking bar 33 to move while driving the horizontal locking tongue 32 to move, so that the horizontal locking tongue 32 is consistent with the vertical locking bar 33 in terms of action, thereby the operation is more convenient and faster.

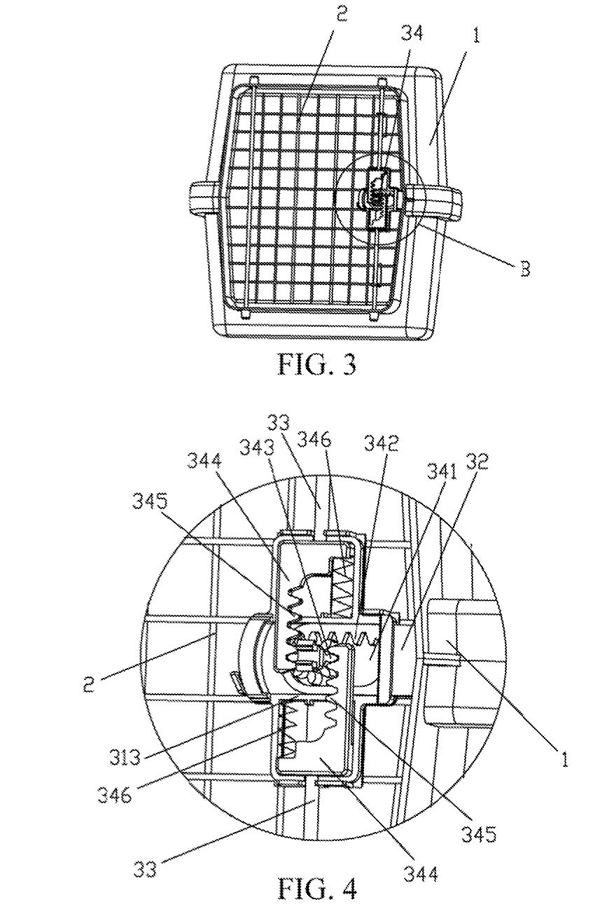

As shown in FIG. 3 to FIG. 6, the drive mechanism 34 comprises an annular groove 341 disposed in the horizontal locking tongue 32, a plurality of convex first teeth 342 are disposed on at least one straight side wall of the annular groove 341, a drive gear 343 matched with the first teeth 342 to drive the horizontal locking tongue 32 to move horizontally is disposed in the annular groove 341, a vertically-arranged vertical sliding block 344 is disposed in the housing 31, a plurality of second teeth 345 capable of being matched with the drive gear 343 to drive the vertical sliding block 344 to move vertically are disposed on the vertical sliding block 344, and the vertical locking bar 33 is connected onto the vertical sliding block 344.

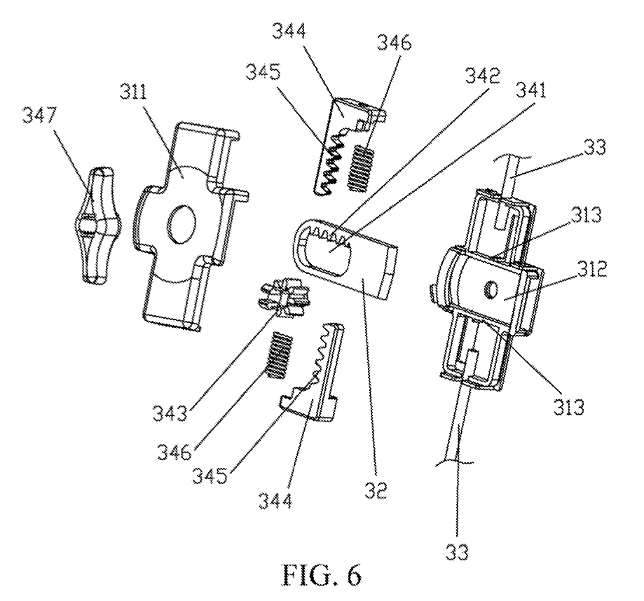

As shown in FIG. 4 and FIG. 6, a first reset spring 346 used for moving the vertical sliding block 344 to reset is disposed in the housing 31.

As shown in FIG. 4 to FIG. 6, two vertical sliding blocks 344 are arranged, and are disposed on the upper and lower sides of the horizontal locking tongue 32, the second teeth 345 on the two vertical sliding blocks 344 are respectively matched with the drive gear 343 so that the two vertical sliding blocks 344 may vertically move towards each other in opposite directions or move backwards when the drive gear 343 rotates, two vertical locking bars 33 are arranged, and are connected with the vertical sliding blocks 344, and the two bars are matched with an upper frame and a lower frame of the door frame 1 respectively. Such a structure realizes 3 locking points between the door 2 and the door 1, which avoids the pet from running out of a pet cage.

As shown in FIG. 4 and FIG. 6, the housing 31 comprises an upper housing 311 and a lower housing 312, the lower housing 312 is internally provided with a horizontal bar 313, and the first reset spring 346 is disposed between the vertical sliding block 344 and the horizontal bar 313.

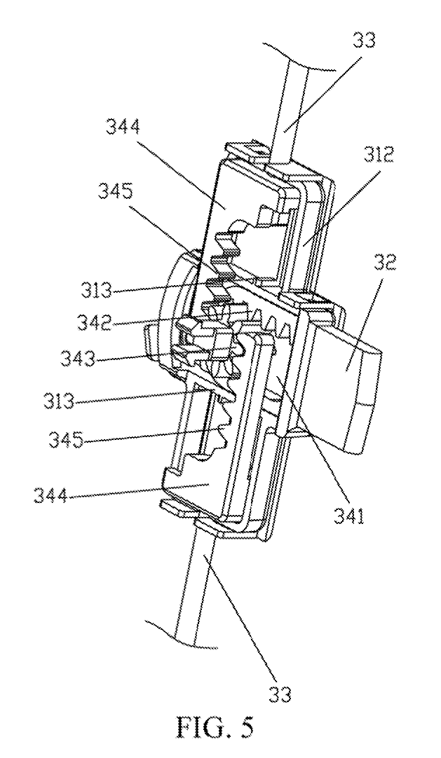

As shown in FIG. 2 and FIG. 5, a rotating handle 347 exposed out of the housing 31 is connected onto the drive gear 343.

When the door 2 needs to be opened, the drive gear 343 is rotated by the rotating handle 347 and the drive gear 343 is matched with the first teeth 342 on the horizontal locking tongue 32 to drive the horizontal locking tongue 32 to quit from the horizontal socket of the door frame 1. While the drive gear 343 is matched with the horizontal locking tongue 32, the drive gear 343 is matched with the second teeth 345 on the vertical sliding block 344, which in turn drives the vertical sliding block 344 to move vertically, thereby driving the vertical locking bar 33 on the vertical sliding block 344 to quit from the vertical socket in the door frame 1, thus finishing the unlocking between the door 2 and the door frame 1. The present utility model has a simple structure, and is easy and quick for a user to operate. During the rotation of the drive gear 343, the horizontal locking tongue 32 is driven to move horizontally and the vertical sliding blocks 344 on both sides of the horizontal locking tongue 32 are driven to move vertically, so that the 3 locking points between the door 2 and the door frame 1 are unlocked at the same time, which is very simple and quick.

3 locking points are arranged between the door frame 1 and the door 2, which avoids the pet from running out of the pet cage. During the movement of the vertical sliding block 344, the first reset spring 346 is compressed. When the door is fully opened and the rotating handle 347 is released, the first reset spring 346 is extended to drive the vertical sliding block 344 to move vertically so as to drive the drive gear 343 to rotate, thereby enabling the horizontal locking tongue 32 and the vertical locking bar 33 to protrude. Therefore, when the door 2 is to be closed, it is only necessary to rotate the rotating handle 347 to enable the horizontal locking tongue 32 and the vertical locking bar 33 to move horizontally and vertically to retract respectively, at which time, the first reset spring 346 is compressed. When the horizontal locking tongue 32 and the vertical locking bar 33 are aligned with the horizontal and vertical sockets in the door frame 1 respectively, the rotating handle 347 is released, and the horizontal locking tongue 32 and the vertical locking bar 33 are protruded again under the action of the first reset spring 346, thus finishing locking between the door 2 and the door frame 1.

### Embodiment 2

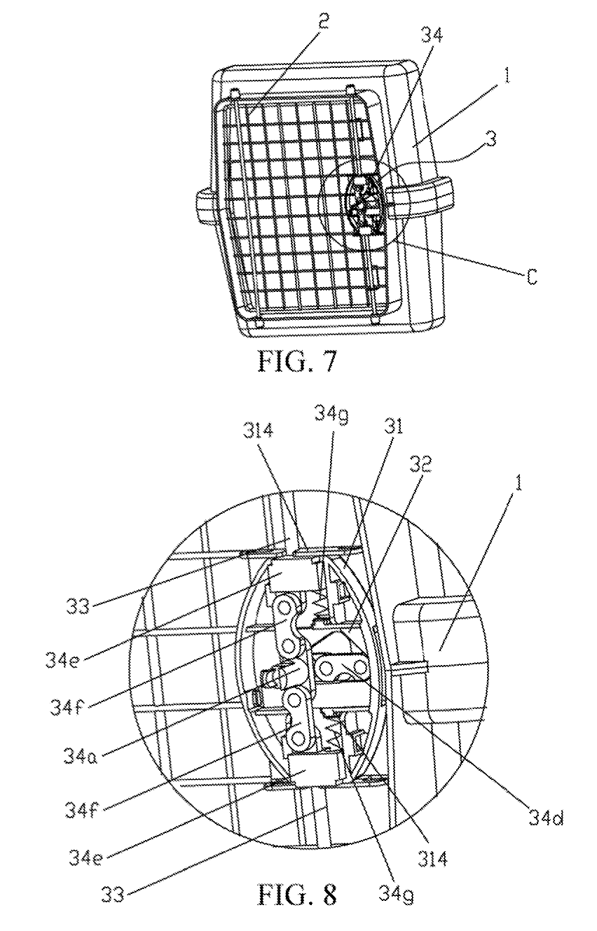

As shown in FIG. 7 and FIG. 8, a new pet cage door comprises a door frame 1 and a door 2 capable of opening and closing relative to the door frame 1, and a locking device 3 is disposed between the door 2 and the door frame 1. The locking device 3 comprises a housing 31 disposed on the door 2, a horizontal locking tongue 32 which is horizontally movable to insert into a horizontal socket in the door frame 1 is disposed in the housing 31, a vertical locking bar 33 which is vertically movable to insert into a vertical socket in the door frame 1 is disposed in the housing 31, and the housing 31 is also provided with a drive mechanism 34 which is matched with the horizontal locking tongue 32 and drives the vertical locking bar 33 to unlock while driving the horizontal locking tongue 32 to unlock.

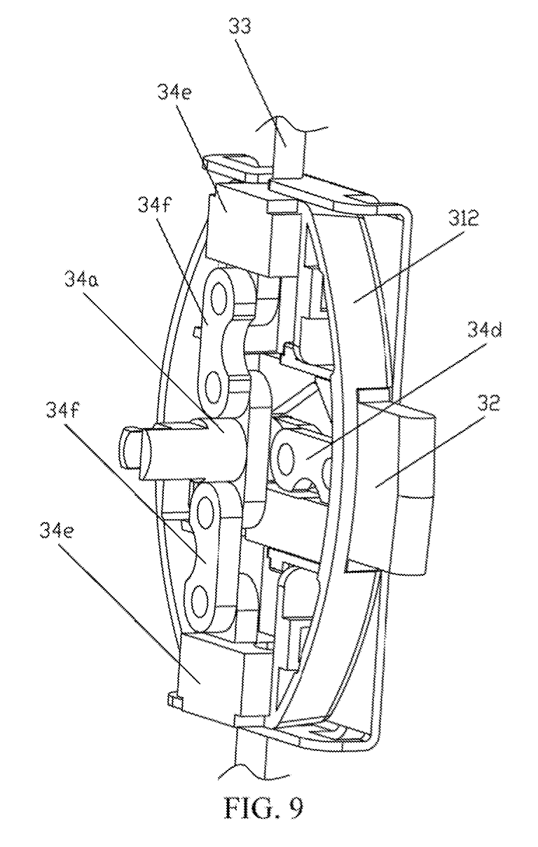

As shown in FIG. 7 to FIG. 10, the drive mechanism 34 comprises a rotating bar 34a capable of rotating in the housing 31, a horizontal hinge part 34b and a vertical hinge part 34c are disposed on the rotating bar 34a, a first interlocking plate 34d hinged with the horizontal hinge part 34b and the horizontal locking tongue 32 is disposed therebetween, the housing 31 is internally provided with a vertical sliding base 34e capable of sliding up and down therein, a second interlocking plate 34f hinged with the vertical hinge part 34c and the vertical sliding base 34e is disposed therebetween, and the vertical sliding base 34e is connected with the vertical locking bar 33.

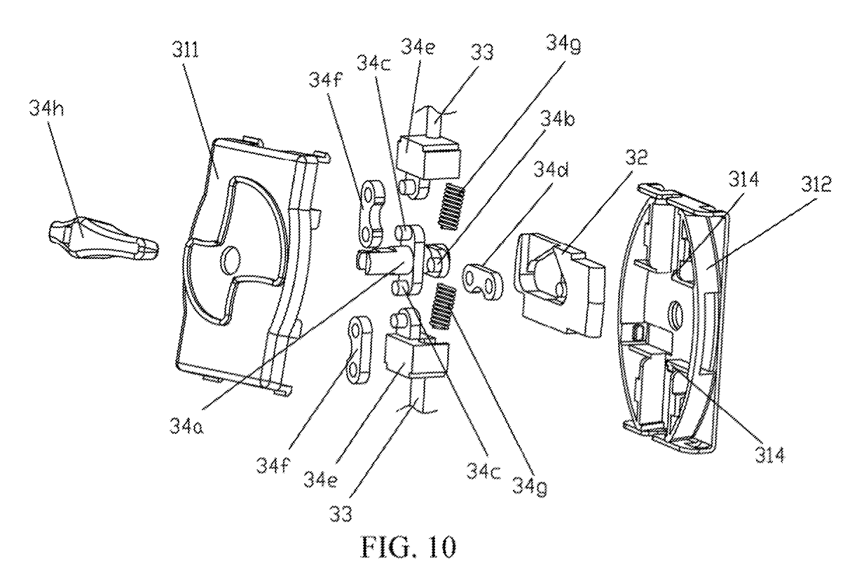

As shown in FIG. 8 and FIG. 10, a second reset spring 34g used for moving the vertical sliding base 34e to reset is disposed in the housing 31.

As shown in FIG. 8 to FIG. 10, two vertical sliding bases 34e are arranged, and are disposed on the upper and lower sides of the horizontal locking tongue 32 respectively, the number of the vertical hinge parts 34c on the rotating bar 34a is two and the two parts are disposed on the upper and lower sides of the horizontal hinge part 34b respectively, and the number of the second interlocking plates 34f is two and the two plates are disposed on the upper and lower sides of the horizontal locking tongue 32 respectively to connect the corresponding vertical sliding base 34e and vertical hinge part 34c. Such a structure realizes 3 locking points between the door 2 and the door 1, which avoids a pet from running out of a pet cage.

As shown in FIG. 8 and FIG. 10, the housing 31 comprises an upper housing 311 and a lower housing 312, the lower housing 312 is internally provided with a horizontal plate 314, and the second reset spring 31 is disposed between the vertical sliding base 34e and the horizontal plate 314.

As shown in FIG. 10, a rotating handle 34h exposed out of the housing 31 is connected onto the rotating bar 34a. The rotating handle 34h is disposed to facilitate the rotation of the rotating bar 34a.

When the door 2 needs to be opened, the rotating bar 34a is rotated by the rotating handle 34h, the rotating bar 34a pulls the horizontal locking tongue 32 through the first interlocking plate 34d so as to drive the horizontal locking tongue 32 to quit from the horizontal socket of the door frame 1. When the rotating bar 34a is matched with the horizontal locking tongue 32 through the first interlocking plate 34d, the rotating bar 34a is matched with the vertical sliding base 34e through the second interlocking plate 34f so as to drive the vertical sliding base 34e to move vertically, thereby driving the vertical locking bar 33 on the vertical sliding base 34e to quit from the vertical socket in the door frame 1, thus finishing the unlocking between the door 2 and the door frame 1. The present utility model has a simple structure, and is easy and quick for a user to operate. During the rotation of the rotating bar 34a, the horizontal locking tongue 32 is driven to move horizontally and the vertical sliding bases 34e on both sides of the horizontal locking tongue 32 are driven to move vertically, so that the 3 locking points between the door 2 and the door frame 1 are unlocked at the same time, which is very simple and quick. 3 locking points are arranged between the door frame 1 and the door 2, which avoids the pet from running out of the pet cage. During the movement of the vertical sliding base 34e, the first reset spring 346 is compressed. When the door is fully opened and the rotating handle 347 is released, the second reset spring 34g is extended to drive the vertical sliding base 34e to move vertically so as to drive the rotating bar 34a to rotate, thereby enabling the horizontal locking tongue 32 and the vertical locking bar 33 to protrude. Therefore, when the door 2 is to be closed, it is only necessary to rotate the rotating bar 34a to enable the horizontal locking tongue 32 and the vertical locking bar 33 to move horizontally and vertically to retract respectively, at which time, the second reset spring 34g is compressed. When the horizontal locking tongue 32 and the vertical locking bar 33 are aligned with the horizontal and vertical sockets in the door frame 1 respectively, the rotating bar 34a is released, and the horizontal locking tongue 32 and the vertical locking bar 33 are protruded again under the action of the second reset spring 34g, thus finishing the locking between the door 2 and the door frame 1.

1. A new pet cage door, comprising a door frame and a door capable of opening and closing relative to the door frame, a locking device being disposed between the door and the door frame, wherein the locking device comprises a housing disposed on the door, a horizontal locking tongue which is horizontally movable to insert into a horizontal socket in the door frame is disposed in the housing, a vertical locking bar which is vertically movable to insert into a vertical socket in the door frame is disposed in the housing, the housing is also provided with a drive mechanism which is matched with the horizontal locking tongue and drives the vertical locking bar to unlock while driving the horizontal locking tongue to unlock.

2. The new pet cage door according to claim 1, wherein the drive mechanism comprises an annular groove disposed in the horizontal locking tongue, a plurality of convex first teeth are disposed on at least one straight side wall of the annular groove, a drive gear matched with the first teeth to drive the horizontal locking tongue to move horizontally is disposed in the annular groove, a vertically-arranged vertical sliding block is disposed in the housing, a plurality of second teeth capable of being matched with the drive gear to drive the vertical sliding block to move vertically are disposed on the vertical sliding block, and the vertical locking bar is connected onto the vertical sliding block.

3. The new pet cage door according to claim 1, wherein a first reset spring used for moving the vertical sliding block to reset is disposed in the housing.

4. The new pet cage door according to claim 1, wherein the drive mechanism comprises a rotating bar capable of rotating in the housing, a horizontal hinge part and a vertical hinge part are disposed on the rotating bar, a first interlocking plate hinged with the horizontal hinge part and the horizontal locking tongue is disposed therebetween, the housing is internally provided with a vertical sliding base capable of sliding up and down therein, a second interlocking plate hinged with the vertical hinge part and the vertical sliding base is disposed therebetween, and the vertical sliding base is connected with the vertical locking bar.

5. The new pet cage door according to claim 4, wherein a second reset spring used for moving the vertical sliding base to reset is disposed in the housing.

6. The new pet cage door according to claim 2, wherein two vertical sliding blocks are arranged, and are disposed on the upper and lower sides of the horizontal locking tongue, the second teeth on the two vertical sliding blocks are respectively matched with the drive gear so that the two vertical sliding blocks may vertically move towards each other in opposite directions or move backwards when the drive gear rotates, two vertical locking bars are arranged, and are connected with the vertical sliding blocks, and the two bars are matched with an upper frame and a lower frame of the door frame respectively.

7. The new pet cage door according to claim 4, wherein two vertical sliding bases are arranged, and are disposed on the upper and lower sides of the horizontal locking tongue respectively, the number of the vertical hinge parts on the rotating bar is two and the two parts are disposed on the upper and lower sides of the horizontal hinge part respectively, and the number of the second interlocking plates is two and the two plates are disposed on the upper and lower sides of the horizontal locking tongue respectively to connect the corresponding vertical sliding base and vertical hinge part.

8. The new pet cage door according to claim 3, wherein the housing comprises an upper housing and a lower housing, the lower housing is internally provided with a horizontal bar, and the first reset spring is disposed between the vertical sliding block and the horizontal bar.

9. The new pet cage door according to claim 5, wherein the housing comprises the upper housing and the lower housing, the lower housing is internally provided with a horizontal plate, and the second reset spring is disposed between the vertical sliding base and the horizontal plate.

10. The new pet cage door according to claim 2, wherein a rotating handle exposed out of the housing is connected onto the drive gear.

11. The new pet cage door according to claim 3, wherein two vertical sliding blocks are arranged, and are disposed on the upper and lower sides of the horizontal locking tongue, the second teeth on the two vertical sliding blocks are respectively matched with the drive gear so that the two vertical sliding blocks may vertically move towards each other in opposite directions or move backwards when the drive gear rotates, two vertical locking bars are arranged, and are connected with the vertical sliding blocks, and the two bars are matched with an upper frame and a lower frame of the door frame respectively.

12. The new pet cage door according to claim 5, wherein two vertical sliding bases are arranged, and are disposed on the upper and lower sides of the horizontal locking tongue respectively, the number of the vertical hinge parts on the rotating bar is two and the two parts are disposed on the upper and lower sides of the horizontal hinge part respectively, and the number of the second interlocking plates is two and the two plates are disposed on the upper and lower sides of the horizontal locking tongue respectively to connect the corresponding vertical sliding base and vertical hinge part.

13. The new pet cage door according to claim 3, wherein a rotating handle exposed out of the housing is connected onto the drive gear.
